(19) United States
(12) Patent Application Publication
(10) Pub. No.: US 2014/0216157 A1
(43) Pub. Date: Aug. 7, 2014

(54) Method for Determining Arc Discharge as well as Failure of Mechanical Vibration and Abnormal Displacement in Power Equipment Using Acoustic Energy Feature

(71) Applicant: Tzu-Feng Wang-Lee, Tainan City (TW)

(72) Inventor: Tzu-Feng Wang-Lee, Tainan City (TW)

(21) Appl. No.: 13/951,540

(22) Filed: Jul. 26, 2013

(30) Foreign Application Priority Data
Feb. 5, 2013 (TW) 102104513

(51) Int. Cl. G01N 29/00

(52) U.S. Cl. CPC G01N 29/00
USPC 73/579; 73/584

(57) ABSTRACT

The present invention provides a method for determining arc discharge as well as failure of mechanical vibration and abnormal displacement in power equipment using acoustic energy feature. Here, acoustic energy feature is firstly introduced to realize real-time, online inspection of failure in power equipment, enabling qualitative determination of discharge as well as mechanical vibration and abnormal displacement, so as to improve early warning before damage. Two factors, in which one is early detection of discharge, and the other is early detection of mechanical vibration and abnormal displacement, are considered. When abnormality of any one of these factors is emerged, it is demonstrated that hidden trouble is presented. Here, acoustic energy feature is used to perform real-time, online monitoring. Due to reliable diagnosis and strong interference resistance provided by sound source signals, the operating condition in which the equipment is situated may be reflected clearly, avoiding damage to electric power grid.

### BACKGROUND OF THE INVENTION

1. Technical Field

The present invention provides a method for determining arc discharge as well as failure of mechanical vibration and abnormal displacement in power equipment using acoustic energy feature, related to the field of online real-time monitoring of power equipment, particularly to a method for determining electric discharge as well as failure of mechanical abnormal displacement and vibration inside power equipment using acoustic energy feature (20 Hz-20 kHz) and vibration frequency.

2. Description of Related Art

Both acoustic wave and vibration wave are considered as mature technology, and may be developed broadly in power industry with good prospects if they are used in combination with each other.

Method for inspection of power equipment may be classified into offline and online inspection methods. Offline inspection should be performed during a power outage. After power is cut, the status of equipment may be not conformed to that in operation, thus affecting accuracy of determination and being incapable of determining operating condition, particularly being incapable of reflecting mechanical performance. Offline inspection method is a periodic test, not a continuous real-time, operating condition inspection, lacking of reliable information about operating status of equipment with more significant aimlessness and limitation. Thus, more waste in human and natural resources, and even unnecessary damage to equipment may be resulted. For instance, in a preventive insulation test on power equipment during a power outage, the main inspection items include dielectric loss, capacitance, insulation resistance, leakage current, DC resistance and insulating oil/gas, as well as the main shortcoming resides in inspection in non-operating condition. Thus, the obtained data should be still determined synthetically, as well as going on an inspection tour seriously in operation and confirming period of next maintenance during a power outage rationally are required. According to statics, more than 70% damage of power transformers in operation is caused by failure of windings or cores. In online inspection method, real-time information of equipment is grasped by maintenance and operation staffs anytime and anywhere in the live line status, facilitating the determination of whether performance of equipment is reduced as well as whether maintenance is required. Therefore, duration of a power outage is reduced. Current development trend of monitoring operating condition of power equipment is to achieve merits including the reduction in damage to equipment caused by periodic maintenance and accident caused by improper maintenance, the reduction in human, natural and funding resources required for maintenance, reduction in staffs on duty and human-made accident.

At present, there are several test methods on equipment during a power outage, according to IEC Standards, generally performed during a power outage, incapable of reflecting the possible arc discharge and abnormal vibration in the operating condition. Thus, there is disadvantage that accidents could not be prevented until now. There are several online test methods on power equipment home and abroad, commonly including ultrasonic wave partial discharge method (without significant effect in practice and still under discussion with respect to online inspection), online insulating oil chromatography (limited to chemical analysis and condition of insulating oil), SF6 gas moisture measurement (limited to insulation level of SF6 gas, possibly performed on live line, but not online work), infrared thermometry (limited to abnormal temperature, incapable of inspecting internal fault of equipment), online interface loss method on capacitive substation equipment (still incapable of solving the problem of “distortion” in picking up signal of mutual induction transducer until now) and etc. Expansion of functions achieved by the present invention could not be realized by these methods owing to their limitation, one-sideness and uncertainty).

### SUMMARY OF THE INVENTION

Frequency spectrum in respect to abnormal status of equipment should be enriched further, so as to be meaningful in the identification of locations and properties of defects in equipment as well as quantitative analysis. Frequency spectrum of equipment may be varied due to difference in principle, structure and material of the equipment, as well as should then be enriched and improved constantly in practice.

There is a method for determining arc discharge as well as failure of mechanical vibration and abnormal displacement in power equipment using acoustic energy feature, characterized in solving the problems and shortcomings presented in the current inspection technology on power equipment. The object of the present invention is to provide a method for determining arc discharge as well as failure of mechanical vibration and abnormal displacement in power equipment using acoustic energy feature. Online, real-time inspection with acoustic energy using sound source of the main body of equipment is allowed for high reliability of inspection, capability of directly reflecting abnormal status of equipment, easy installation, and avoiding safety hazard on electric power grid.

There is provided a method for determining arc discharge as well as failure of mechanical vibration and abnormal displacement in power equipment using acoustic energy feature, characterized in that arc discharge as well as abnormal mechanical vibration and displacement in power equipment may be included in regulated inspection items, and failure inside electrical equipment may be determined on the basis of introduced theory of acoustic energy feature, different from current inspection method.

There is provided a method for determining arc discharge as well as failure of mechanical vibration and abnormal displacement in power equipment using acoustic energy feature, characterized in acoustic energy (acoustic wave, vibration wave) transducer for power equipment (as shown in FIG. 6); vibration wave having frequency response at 0.5 Hz-200 Hz (−3 dB); sensitivity of 8 mV/μm±5% (or otherwise adjustable depending on equipment requirements) for displacement transducer, and of 300 mV/mm/s (or otherwise adjustable depending on equipment requirements) for velocity transducer; acoustic wave having measured sound intensity of 20-140 dB; measured waveform of 0-5V (measured frequency ranged from 20 Hz to 20 kHz); resolution of 1Hz and precision of ±1%. Thus, a substantial inspection method is added for inspection of power equipment. The two types of transducers may be arranged on the appearance of the equipment to be measured, respectively. For simple installation, these two transducers may be integrally formed with, in principle, no interference between two sound source signals, the obtained signal source being conformed to requirement, and independent signal processing circuits.

There is provided a method for determining arc discharge as well as failure of mechanical vibration and abnormal displacement in power equipment using acoustic energy feature, characterized in real-time, online inspection on power equipment for determining if arc discharge as well as vibration and mechanical abnormal displacement may be presented inside the equipment, so as to arrange maintenance for the equipment in time orderly.

There is provided a method for determining arc discharge as well as failure of mechanical vibration and abnormal displacement in power equipment using acoustic energy feature, characterized in that the objects for which this method is used comprise power generators, transformers, inductors, mutual-inductors, capacitors, circuit breakers, arrestors, power transmission (tower) equipment and etc.

The technical effect of the present invention is embodied in that said sound source of the present invention is derived from audible acoustic energy generated from the main body of power equipment, closely related to discharging arc, mechanical abnormal (vibration) displacement inside the equipment. Differently from former means for inspection of electrical parameters, chemical parameters, temperature and etc., the effect of real-time, online inspection on power equipment for examining safety may be achieved.

### BRIEF DESCRIPTION OF THE SEVERAL VIEWS OF THE DRAWINGS

FIG. 1 is a diagram illustrating the principle of an acoustic transducer for power equipment of the present invention.

FIG. 2 is a diagram illustrating the amplitude-frequency characteristic of a transformer of the present invention in normal operation.

FIG. 3 is a diagram illustrating the amplitude-frequency characteristic of the transformer of the present invention in abnormal operation.

FIG. 4 is a full-range time domain diagram of arc discharge signal monitoring of the present invention.

FIG. 5 is a diagram illustrating the principle of online power equipment monitoring system using acoustic energy of the present invention.

FIG. 6 is a flow chart for power inspection of the present invention.

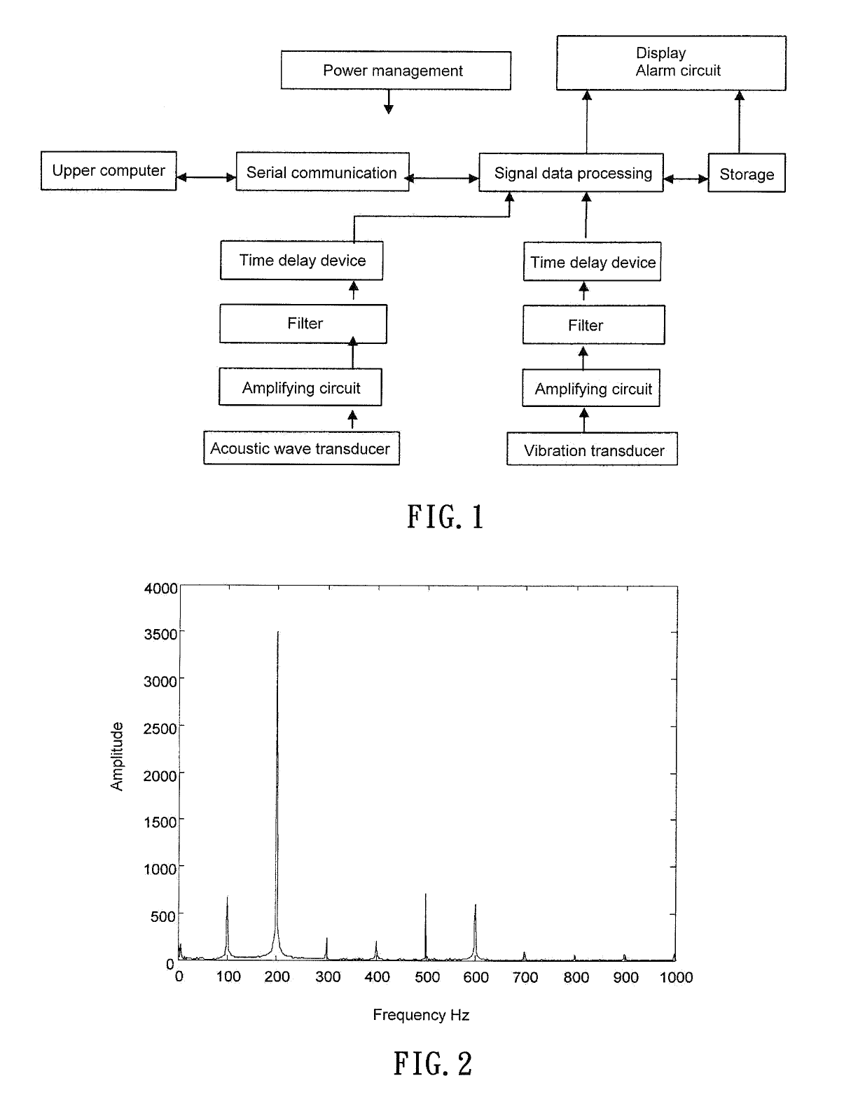

### DETAILED DESCRIPTION OF THE EMBODIMENTS OF THE INVENTION

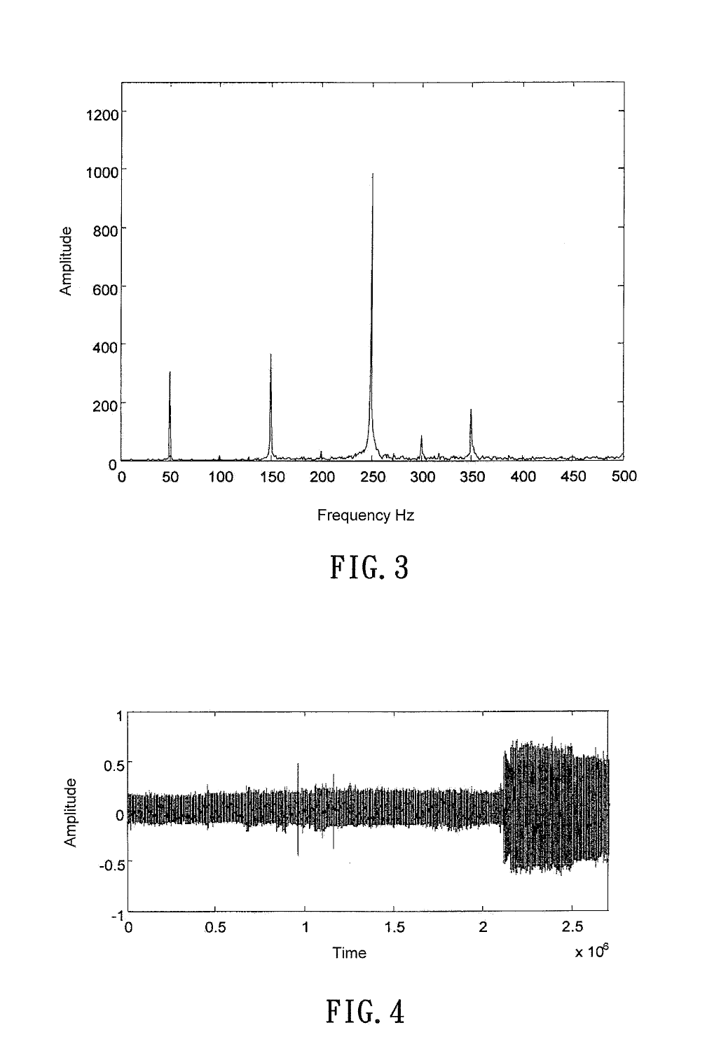

A method for determining arc discharge as well as failure of mechanical vibration and abnormal displacement in power equipment using acoustic energy feature devised in the present invention is based on principles, the first one of which is the utilization of acoustic wave and vibration wave, in such a way that power equipment may be inspected to determine arc discharge and mechanical failure therein. A transformer is a “heart” of a substation. Taking the transformer as an example, the vibration of the main body of the transformer is determined by the vibration of core entirely, while the vibration of core may be approximated to magnetostriction of silicon steel. The magnetostrictive vibration of core may be transmitted to the wall of oil tank via two paths through either the pad of core or insulating oil medium, such that acoustic wave may be generated by the vibration of wall of oil tank and then emitted in all directions. It is demonstrated that, in the research on several (110 kV) power transformers, the frequency spectrum of noise from core of power transformer is generally ranged from 100 to 500 Hz. The largest frequency-amplitude is emerged at 200 Hz (as shown in FIG. 2), while the largest frequency-amplitude in abnormality is presented around 250 Hz (as shown in FIG. 3). FIG. 4 illustrates electric discharge procedure of power equipment tested in a laboratory. Although one of two kinds of power frequencies, 50 Hz and 60 Hz, may be used in each country, respectively, power equipment, such as power generator, inductor, transformer, capacitor, circuit breaker, tower and etc., may similarly follow acoustic wave characteristic of the power equipment.

The second principle, on which the present invention is based, is arc discharge being caused by over voltage, ageing component, abnormal core, damaged winding, poor contact, jitter resulted from electrodynamic force and etc., in power equipment. The acoustic frequency of equipment in normal operation is shown in FIG. 2, while acoustic frequency of electric discharge in abnormality is shown in FIG. 4, for example.

The third principle, on which the present invention is based, is vibration wave being generated from substation equipment or power transmission tower due to abnormal vibrational mechanical displacement. In the electro-magnetic equipment, not only magnetostriction of core, but also jitter and resonance vibration of components due to electrodynamic force and etc., may occur. The vibration wave of equipment in normal operation may be considered as normal wave, such as vibration signal of core of transformer being mainly concentrated in the range of 100 to 400 Hz. On the contrary, the vibration wave at one frequency deviated from this section of spectrum is considered as abnormality. In the latter, the fault of serious mechanical vibration caused by loose components, near-by short-circuit, poor contact and etc., should be presented in the equipment.

A diagnosis system for arc discharge and abnormal mechanical fault in power equipment is provided. The present invention is related to online monitoring technology using acoustic energy, not related to the formation and selection of components of system.

In a power-related acoustic energy transducer, an acoustic wave interface circuit is composed of the electrode tip of electret and special field-effect transistor (impedance converter), and a vibration interface circuit is composed of vibration transducer (type of which is selected on the basis of vibration characteristic of power equipment).

An amplifying circuit is provided for amplifying weak signals at interface circuits for acoustic wave and vibration wave.

A filter is provided for filtering the two signal sources. The waveform of 205 Hz may be filtered out so as to magnify that of abnormal frequency.

Signal data processing is provided. A well-used microprocessor is utilized as core processor, due to the fact that superior low power and strong capability to resist interference are required by the system circuit, to pick up audio signal data. A 16-bit single-chip microcomputer is used in combination with 16-bit bus, unified addressing externally and internally with addressing range up to 64K. Further, expanded memory is possible. Various modules on chip including 14-channel 12-bit analog-to-digital converter, 2-channel USART communication port, a comparator and etc., are provided.

A power management circuit is provided. A regulated power supply is selected for enable end EN. In the operating status, electrical level passing through the parallel port of microprocessor may be varied, so as to turn on or turn off the power. When the microprocessor is situated in a sleep state, the enable end of the regulated power supply is situated in off state, so as to turn off the power of amplifier and storage. On the contrary, when the microprocessor is woken to work by an upper computer, the regulated power supply is turned on. Power source may be selected from a solar panel with suitable dimension and a battery having adequate capacity.

A time delay circuit is provided. When the transformer is put into operation, the circuit breaker is opened/closed or the power network is disturbed, a transition of acoustic energy is emerged inside the equipment, and abnormality in equipment is thus not reflected. In this case, delayed time may be adjusted in accordance with capacity of equipment together with settings of protection relays.

A display and an alarm circuit are provided. An LCD interface may be used to display parameters selected from power-related acoustic wave, vibration frequency and etc. Alarm may be realized in an acousto-optic manner.

Storage is provided. The system is situated in the sleep state. The microprocessor is woken when an upper computer is allowed to command a lower computer via the serial port. In operation, the microprocessor is allowed to turn on the steady-state power supply first, and the whole circuit system is then started to operate. Simulated signals of acoustic wave and vibration wave are amplified and filtered. After the circuit system is woken, acoustic wave information may be picked up for a period of time, and the picked up acoustic wave information may be then stored in storage.

An acoustic energy transducer for the transformer is provided. When the transducer is installed, it is adhered securely on the outer casing of oil tank of equipment, as well as possibly arranged together with the thermometer and isolated from external sound source. Peak and disturbance in electric power grid, due to quite large inrush current generated when the transformer is closed, should be avoided for the transducer by cooperation with protection relay, so as to prevent error alarm. Still, the acoustic wave on load in the beginning should be ignored. The power-related acoustic energy transducer is positioned in place on the transformer, such that the object of alarming correctly may be obtained. Better effect may be achieved if the transducer is fixed inside the transformer.

An acoustic energy transducer for mutual-inductor, capacitor or arrester is adhered securely on the appearance of equipment near secondary side and isolated from external sound source, when it is installed. The transducer is positioned in place on the mutual-inductor, capacitor or arrester, such that the object of alarming correctly may be obtained.

An acoustic energy transducer for the circuit breaker is provided. This transducer is installed at the bottom of high-voltage circuit breaker, for facilitating observation and maintenance. One transducer is installed for each phase if the circuit breaker is a split-phase one. The transducer should be positioned in place on the circuit breaker for the prevention of error alarm due to stronger vibration generated when the circuit breaker is opened/closed. Thus, the object of alarming correctly may be obtained.

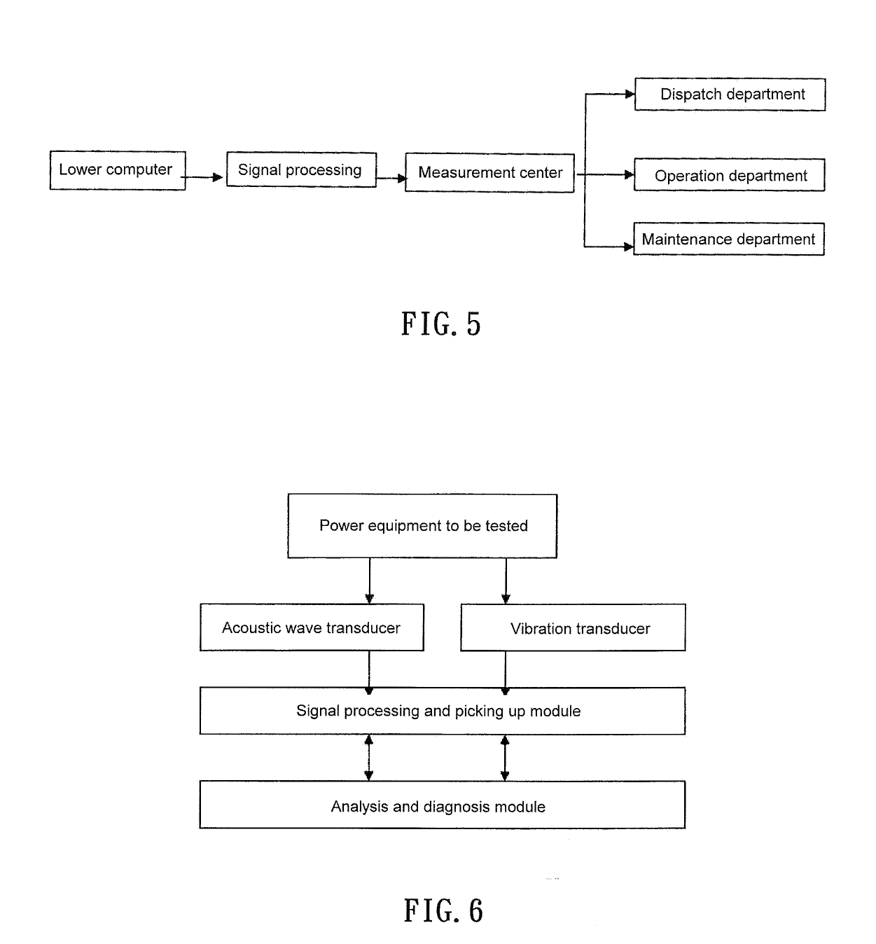

The principle of online monitoring system using acoustic energy for power equipment (as shown in FIG. 5) will be described as follows.

A lower computer is provided for receiving signals picked up from each equipment. Each equipment is featured by one specific frequency. The frequency is scanned periodically in accordance with a certain period, and the abnormal signal related to the inspected equipment may be then sent to a signal processing module.

Signal processing is provided for storing the received abnormal signal and sending it to a measurement center.

The measurement center is provided as a measurement center for acoustic wave in substation, electrical signals picked up from each acoustic wave transducer being converged to the measurement center. Then, an early warning is sent to the substation equipment generating abnormal acoustic wave, and transmitted to a dispatch, operation and maintenance terminal. Once the abnormal equipment is found, the alarm is immediately traced.

The dispatch, operation and maintenance terminal is provided, in which a dispatch department is assigned to change operation mode or draw operation and maintenance departments' attention timely depending on the early warning signal. For the operation department, the staff is assigned to the site timely, depending on the early warning signal, so as to confirm if there is any other abnormality in the equipment by means of observation, such as appearance inspection, meter check, infrared-thermal detection and etc. For the maintenance department, the staff is assigned to the site timely, depending on the early warning signal, to perform hot-line inspection, and maintenance decision is made according to the combined maintenance history of the equipment.

The inspection device for acoustic energy may be also produced as a portable on-site inspection instrument.

In general, the substation is not linked to Internet network, and networking is accomplished in the manner of local area network or others.

The present invention is related to the advancement in inspection technology on power equipment, in such a way that inspection method may be made more scientific and reliable. The present invention is allowed to greatly facilitate the assessment of status of the equipment, as well as provide operation staffs with new demonstration of quantity of state during on-site inspection on equipment. The features of low cost, mature component, easy installation, capability of early warning and significant effect are provided for this technology. Thus, good prospect may be expected in power industry.

In the present invention, qualitative determination of type of fault, provision of basis for maintenance timely, as well as supplement to IEC Standards are possible, resulting in more scientific and comprehensive operation, testing and maintenance.

What is claimed is:

1. A method for determining arc discharge as well as failure of mechanical vibration and abnormal displacement in power equipment using acoustic energy feature, characterized in that power substation equipment is inspected via acoustic energy feature (20 Hz-20 kHz) and frequency of vibration.

2. The method for determining arc discharge as well as failure of mechanical vibration and abnormal displacement in power equipment using acoustic energy feature according to claim 1, wherein acoustic wave and vibration transducer is provided as a manner for picking up to be utilized by an online inspection device using acoustic energy for power equipment.

3. The method for determining arc discharge as well as failure of mechanical vibration and abnormal displacement in power equipment using acoustic energy feature according to claim 2, wherein specific objects for which said method is used comprise power generation equipment, equipment in primary substation and power transmission equipment.

4. A method for determining arc discharge as well as failure of mechanical vibration and abnormal displacement in power equipment using acoustic energy feature, characterized in that an inspection means using acoustic wave and vibration wave is utilized to ascertain if arc discharge as well as serious fault of mechanical vibration and abnormal displacement are presented in the equipment in operation, said method being implemented as a portable on-site inspection instrument using acoustic feature for power equipment, or as a real-time online inspection system on power equipment based on acoustic energy principle.

5. The method for determining arc discharge as well as failure of mechanical vibration and abnormal displacement in power equipment using acoustic energy feature according to claim 1, wherein specific objects for which said method is used comprise power generation equipment, equipment in primary substation and power transmission equipment.
